(19) United States
(12) Patent Application Publication
(10) Pub. No.: US 2009/0315284 A1
(43) Pub. Date: Dec. 24, 2009

(54) CONVERTIBLE LUGGAGE CASE AND CART

(76) Inventor: Ignacio Tapia Osorno, Puebla (MX)

Correspondence Address: ITALIA IP, 3500 WEST OLIVE AVE., SUITE 300, BURBANK, CA, 91505, US

(21) Appl. No.: 12/143,807

(22) Filed: Jun. 22, 2008

(51) Int. Cl. B62B 5/00

(52) U.S. Cl. 280/37

(57) ABSTRACT

A luggage case which is convertible between a first configuration similar to a suitcase and a second configuration similar to a wheeled cart. The luggage case may have wheels and a pivotal handle. The pivotal handle may be supported by a strut pivotally fixed thereto at one end and arranged at the other end to slide along a groove in a guide track fixed to the luggage case. The strut may be entrapped to stop at a predetermined location along the groove with the handle fixed at an angle suitable for pushing the luggage case on its wheels.

### FIELD OF THE INVENTION

The present invention relates to article transporting. More particularly, to a luggage receptacle which is convertible between a hand-held receptacle and a wheeled receptacle.

### BACKGROUND

Personal articles must periodically be carried en masse from one place to another. An example is personal possessions such as clothing, toiletry articles, and the like being brought with a person when that person is traveling. Suitcases intended for carrying such personal articles have been developed with an eye towards improving convenience and utility. Suitcases have for example external gripping handles and retractable handles for drawing a heavy suitcase on wheels provided as part of the suitcase for this purpose.

During travels, it is possible for travelers to have several suitcases, packages, bags, and other receptacles which must be transported simultaneously. While it is usually easy to manage a single suitcase or other travel receptacle, managing three or more such receptacles presents additional problems.

Airports frequently offer travelers wheeled carts to move their luggage from the point of arrival at an airport building such as a passenger terminal to the point where an airline takes responsibility for loading the baggage on an aircraft. These carts remain at the airport. It then becomes necessary to locate another such cart when arriving at the next airport.

There exists a need for the traveling public for luggage which is still more accommodating to managing luggage than existing luggage.

### SUMMARY

The present invention provides a travel case which meets the above stated need. To this end, a novel convertible luggage case according to at least one aspect of the invention comprises at least one receptacle having both wheels and also a handle adapted for both drawing the luggage case on its wheels and also pushing the luggage case on its wheels.

The handle may be a bail type handle which is pivotally connected to the receptacle of the luggage case. A strut which may be pivotally connected to the handle and slidably connected to the receptacle guides the handle along its pivot path and also can lock the handle at a predetermined point along its pivot path.

One end of the strut may ride in a guide track having a groove. The groove may have a downwardly inclined extension enabling the strut to be received therein. When the strut engages the extension of the groove, the strut and hence the handle is fixed in respective predetermined positions. An advantageous position is one in which the handle is particularly suited for pushing the luggage case in the manner of a cart.

The handle is both out of the way of additional articles which may be stacked onto the luggage cart, and may also serve as a backstop to prevent some additional articles from falling off the back, onto the user's feet.

The guide track enables the handle to be released from its operative position described above to assume a stowed position in which it may encircle the receptacle in close cooperation therewith, in a position aligned lengthwise with the receptacle.

The luggage case may have attributes of known luggage devices, incuding for example both fixed direction wheels, variable direction caster wheels, a second traditional handle and a third handle of the traditional retractable type.

When provided in combination, these features enable the luggage cart to be hand carried in the traditional way, pulled with the weight supported on wheels, and pushed with the weight supported on wheels.

The handle structure is unobtrusive and compact in the stowed position.

It is an object of the invention therefore to provide a carrier which is convertible between traditional suitcase usage and wheeled cart usage.

It is another object of the invention to provide a handle which enables both pulling and pushing of the luggage case in the cart configuration.

A further object of the invention is to enable compact, unobtrusive stowage of the handle while not impairing capacity of the receptacle of the luggage case.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a luggage case according to at least one aspect of the invention.

FIG. 2 is a side view of the luggage case of FIG. 1, showing handle movement and ability to carry additional stacked articles.

FIG. 3 is a side view of the luggage case of FIG. 2, showing the stowed position of the handle, and with the additional stacked articles seen in FIG. 2 deleted from the view.

FIG. 4 is an enlarged perspective detail view of connection apparatus of the handle to the receptacle, shown partly in cross section.

FIG. 5 is an enlarged side detail view of the component seen at the left of FIG. 4.

FIG. 6 is a bottom perspective view of the luggage case of FIG. 1.

### DETAILED DESCRIPTION

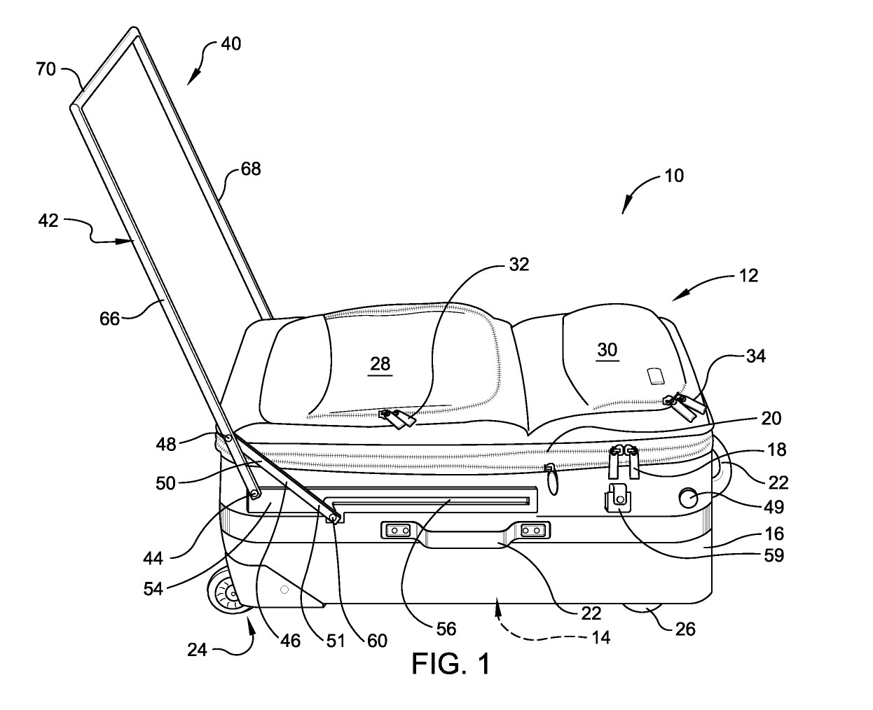

FIG. 1 shows a luggage case 10 according to at least one aspect of the invention. The luggage case 10 may have a receptacle 12 for containing articles (not shown) which are to be carried, stored, or transported, or any combination of these. The receptacle 12 may have a floor 14, a lateral wall 16 which projects from the floor 14, and a closure 18. The floor 14, the lateral wall 16, the closure 18, or any combination of these, may comprise a flexible material such that at least part of the receptacle 12 is flexible. Plastics, leather, canvas, other fabrics, and combinations of these, with or without stiffeners, reinforcements, water proofing materials, and other components, as are well known in the art, may be employed.

As employed herein, the term wall, such as the lateral wall 16, is used with an eye to semantic convenience. It would be possible by merely reorienting a convertible luggage case such as the luggage case 10 according to one or more aspects of the invention, such as by tipping the convertible luggage case onto its side, such that the closure, such as the closure 18, forms part of the lateral wall, such as the lateral wall 16, the floor, such as the floor 14, becomes a part of the lateral wall, and that portion of the lateral wall which was in one orientation part of the wall to assume the function of the floor. Therefore, it will be understood that structural terms such as floor and wall do not connote that any particular orientation of the convertible luggage case assume criticality in defining the invention.

As employed herein, orientational terms such as up, down, right, left, front, rear, and the like relate to how the subject matter is depicted in the referenced figures. Obviously, a luggage case such as the luggage case 10 may be carried or positioned in many ways, with different sides facing upwardly depending upon positioning.

It should also be understood that the term wall may encompass more than one continuous member in that it may be formed in sections which may abut, overlap in part, or not contact one another (none of these arrangements is shown).

It will be appreciated that the receptacle 12 may have flexible or flaccid walls, closure, and floor, or any combination of these.

A closure fastener which is manually closable to define and close a storage compartment within the floor 14 and the lateral wall 16, in the form of a slide fastener 20, of the type popularly called a zipper, may be provided to enable the closure 18 to be closed.

A tote handle 22 may be affixed to the lateral wall 16, for carrying the luggage case 10 with all of its weight borne by hand.

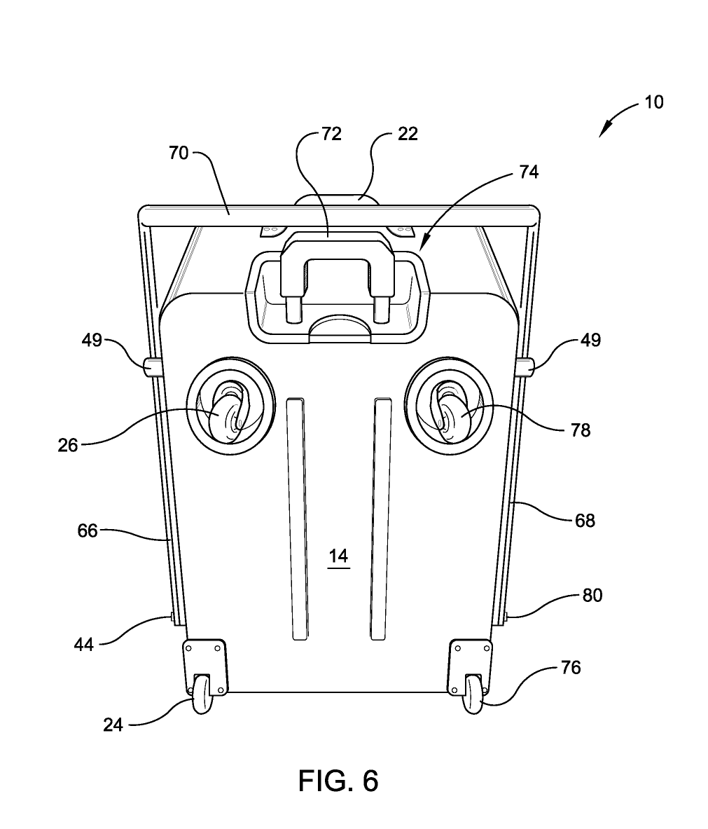

The luggage case 10 may have at least two ground engaging wheels. A fixed wheel 24 may be built into the floor 14 to enable the luggage cart 10 to be wheeled along a floor surface. A second fixed wheel 76, not visible in FIG. 1 (see FIG. 6), may be provided towards the concealed side of the receptacle 12, for added stability when rolling the luggage cart 10 along the floor surface. A caster wheel 26 may be attached to the floor 14 at the right side of the receptacle 12, as depicted. A second caster wheel 78, not visible in FIG. 1 (see FIG. 6), may be provided towards the concealed side of the receptacle 12. A fixed wheel is a wheel which is mounted so that its direction of travel along the floor surface is fixed in its orientation relative to the luggage case 10, and may be considered to be fixed in direction. Fixed in direction does not, of course, refer to direction of rotation about an axis of rotation. By contrast, a caster wheel is an example of a wheel of variable direction. A wheel of variable direction has a mounting enabling the wheel to travel in different directions relative to orientation to the luggage case 10. A wheel of variable direction may be other than a caster wheel.

The receptacle 12 may have auxiliary independently closable receptacles 28 and 30, each having respective slide fasteners 32 and 34. The slide fastener 32 may comprise two handles and track joining members each of which is independently movable along and capable of joining and separating toothed tracks.

Of particular interest is a pivotal handle assembly 40, which renders the luggage case 10 readily convertible between a carried condition and a drawn and pushed wheeled condition. In the carried condition, the luggage case 10 is typically carried by grasping on of two tote handles 22, with the luggage case 10 carried out of contact with the ground or floor. In a drawn wheeled condition, the wheels, such as the wheels 24 and 26, contact the floor. Propulsion is accomplished by drawing or pulling on a bail handle 42. Of further interest is that in the condition depicted in FIG. 1, the luggage case 10 can be pushed along the floor surface. In the pushed wheeled condition, the wheels, such as the wheels 24, 76 and 26, 78 contact the floor. Propulsion is accomplished by pushing on the bail handle 42.

The bail handle 42 may be pivotally mounted on the receptacle 12 by a pivot mounting 44. The pivot mounting 44 may be a trunnion bearing or any member fixed to the receptacle 12, about which the bail handle 42 can pivot.

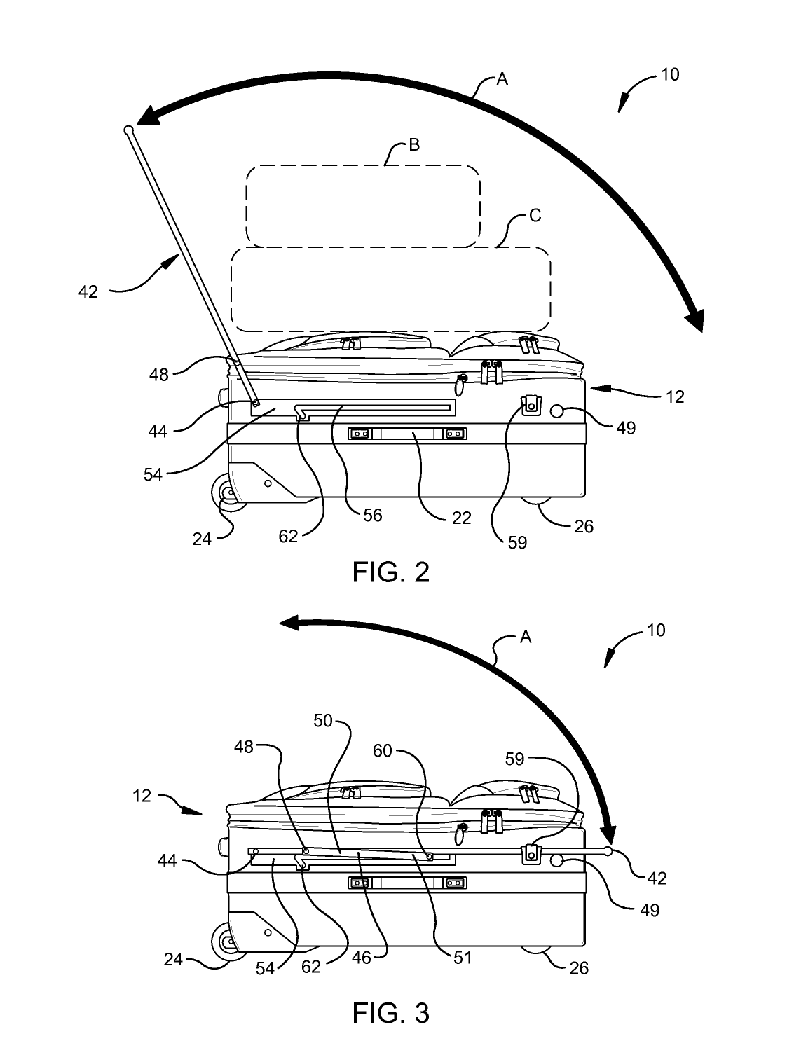

FIG. 2 illustrates pivot of the bail handle 42, pivot being represented as an arrow A. FIG. 2 also illustrates use of the luggage case 10 to carry additional articles, such as travel bags B and C. In FIG. 2, the support strut 46 has been omitted to show the underlying structure, namely the track 54 which includes a groove 56 and slot extension 62, said structures discussed more fully below.

FIG. 3 illustrates the limit of pivot of the bail handle 42. The bail handle 42, when swung fully to the lower right of FIG. 3, is limited in its range pivot upon contacting a stop 49. The stop 49 may comprise rubber, a synthetic elastomer, or other resilient material which is mounted to the receptacle 12. The stop 49 may be located on the receptacle such that the handle member 42 is longitudinally aligned with the receptacle 12 at the limit of the range of pivot. The longitudinally aligned position is shown in FIG. 3. A retainer 59 releasably retains the handle member 42 at the limit of its range of pivot. The retainer 59 may comprise a tab of flexible material bearing a snap, a hook, adhesive, hook and loop fastener, a clip, or any other fastener which holds the bail handle 42 in the longitudinally aligned position shown, either acting on its own, or by acting in concert with the stop 58.

It will be appreciated that while the stop 49 limits the range of pivot of the bail handle 42 at one end of the range, the support strut 46 limits the range of pivot at the other end of the range.

Referring again to FIG. 1, a support strut 46 is dynamically connected to both the bail handle 42 and the receptacle 12. As shown in FIG. 1, a first end 50 of the support strut 46 is pivotally anchored to the bail handle 42 at a pivot 48. A second end 51 of the support strut 46 slidably engages a guide in the form of a track 54 having a groove 56.

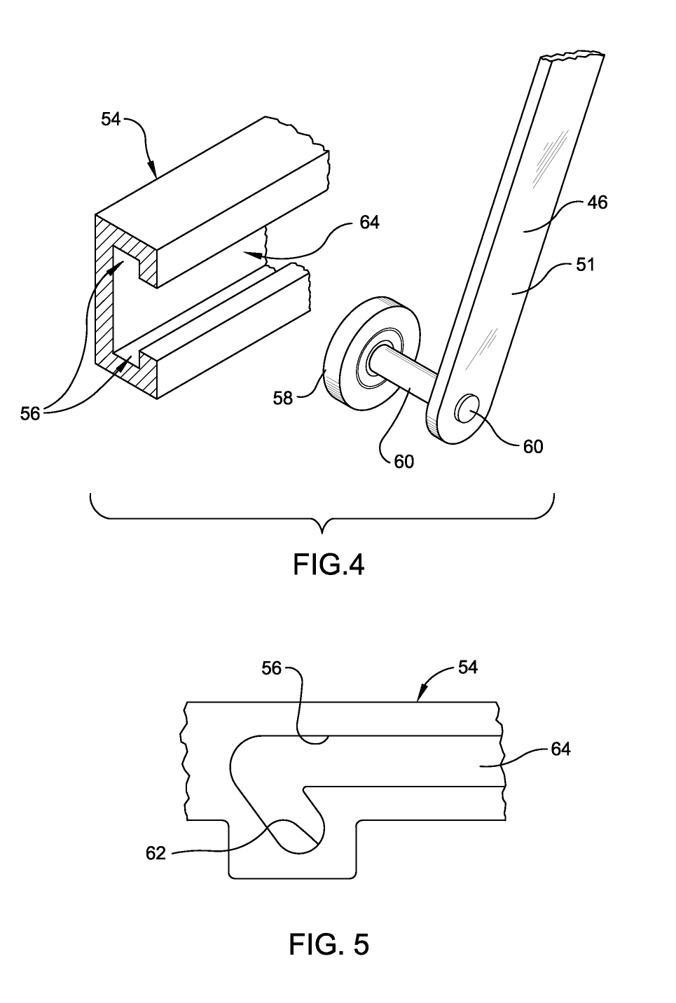

Details of the track 54 and its engagement by the bail handle 42 are better seen in FIGS. 4 and 5. In FIG. 4, it will be seen that the track 54 includes a generally C-shaped groove 56 which receives the enlarged head 58 of a pin 60. The pin 60 is fixed to the lower end 51 of the support strut 46 (not shown in its entirety). The enlarged head 58 slidably rides within the groove 56, with the pin 60 passing through a narrow slot 64 formed along the length of the groove 56. The support strut 46 is thereby guided at its lower end 51 by the track 54.

The track 54 may be mounted to the receptacle 12 of the luggage case 10, with the support strut 46 dynamically connected at its upper end 50 to the bail handle 42 at the pivot 48 such that when the bail handle 42 is raised from its stored position in FIG. 3 to its operational predetermined position in FIG. 2, the pin 60 is guided along the groove 56 of the track 54.

It would also be possible to mount a support strut comparable in function to the support strut 46 pivotally to both the track 54 and the bail handle 42, with a sliding connection such as telescoping construction located between the two pivots (this arrangement is not shown). In such a case, a pin having an enlarged head and an associated guide track in which the enlarged head rides could be incorporated into the telescoping sections and possibly concealed from view. Alternatively, any known detent device which accommodates longitudinal extension could be used in place of a pin and a groove.

An advantage of the arrangement of FIG. 1, wherein the support strut 46 is mounted to the receptacle 12 at the exterior of the latter is that the entire upper surface of the receptacle 12 is available to serve as a platform for receiving additional stacked articles thereon, as seen in FIG. 2. Alternatively stated, neither the bail handle 42 nor the support strut 46 intrudes upon the platform area so generated.

FIG. 5 shows a detent feature which is disposed to releasably secure the support strut 46 in a predetermined position, and wherein the bail handle 42 is secured in a respective predetermined position responsively to the support strut 46 being secured in its predetermined position. FIG. 1 illustrates exemplary predetermined positions of both the bail handle 42 and also the support strut 46. The predetermined position of the bail handle 42 is convenient for pushing the luggage cart 10 along a ground or floor surface.

Referring again to FIG. 5, the detent feature comprises a slot extension 62 which intersects the groove 56 such that the pin 60 can enter the slot extension 62 and be entrapped therein, thereby securing support strut 46 in the predetermined position. Note that the slot extension 62 is generally downwardly directed, such that the pin 60 can drop into the slot extension 62 by force of gravity. The support strut 46 is readily withdrawn from the predetermined position by lifting the bail handle 42 and maneuvering the support strut 46 past the slot extension 62 for example to return the bail handle 42 to the stowed position shown in FIG. 3.

In the depiction of FIG. 5, the slot extension 62 is shown at a tab or enlargement formed in the track 54. This tab is shown only for visual emphasis directing attention to the slot extension 62, and need not be provided.

Note that the slot extension 62 is arranged at an oblique angle to a horizontal direction with the lower end of the slot extension 62 located further from the bail handle 42 than is the point of intersection of the slot extension 62 with the groove 56 of the guide or track 54. This arrangement assures that pushing forces imposed by a user on the bail handle 42 will promote engagement of the pin 60 with the slot extension 62 and simultaneously will oppose disengagement of the pin 60 from the slot extension 62.

Referring again to FIG. 1, the bail handle 42 may comprise a first leg 66 which engages the receptacle 12 at a first lateral side thereof at the pivot mounting 44, and a second leg 68 which engages the receptacle at a second lateral side thereof by a pivot mounting (not visible, but which may be for example a mirror image of the pivot mounting 44), and a spanning member 70 which spans and connects the first leg 66 and the second leg 68. In FIG. 1, the first lateral side is that bearing the track 54 and the second lateral side, which is opposed to the first lateral side, is that side concealed from view in FIG. 1.

Turning now to FIG. 6, the luggage case 10 may comprise, in addition to the bail handle 42 and the tote handle 22, a further handle 72 which is retractably extensible from the receptacle 12 for deployment and which at least partially is received within the receptacle 12 for stowage. In the stowed condition depicted in FIG. 6, access to the handle 72 is located in a recess 74 formed in the receptacle 12.

A further feature clearly seen in FIG. 6 is an arrangement of wheels. Fixed wheel 24 is seen to have as a counterpart a second fixed wheel 76. Similarly, the caster wheel 26 is seen to have as a counterpart a second caster wheel 78. The types of wheels, whether of the fixed or variable direction type, the locations of wheels, and the number of wheels may be varied to suit.

A pivot mounting 80 may be provided at the other side of the receptacle 12, for pivotal mounting of the lower end of the leg 68 (see FIGS. 1 and 6) of the bail handle 42.

It would be possible to mount a second track (not shown, but which could be for example a mirror image of the track 54) on the same side of the receptacle 12 as the pivot mounting 80, if it was desirable to provide a second support strut (not shown, but functionally similar to the support strut 46).

A luggage cart according to at least one aspect of the invention, such as the luggage cart 10, may be provided with any amenity which facilitates or improves handling thereof throughout a journey. Illustratively, such a luggage cart may be provided with a radio frequency identification chip or apparatus for example for being scannable or readable by machine for location and security purposes. The novel luggage cart may have a data processing device for receiving or transmitting data or both. The novel luggage cart may incorporate a Global Positioning Sensor device in furtherance of monitoring and reporting of location. The novel luggage cart may incorporate a communications device other than of the RFID type if desired, to facilitate tracking, monitoring, acquiring, and reporting of data, images, sensed conditions, and other aspects of information related to the condition and location of the luggage cart. None of these amenities is shown.

A luggage cart according to at least one aspect of the invention, such as the luggage cart 10, may be used for purposes other than those traditionally associated with personal travel. The receptacle of the luggage cart may be open in that the closure, such as the closure 18, is omitted. Any of the floor, lateral wall, or the closure if provided, or any combination or part of these, may be made rigid. A luggage cart according to at least one aspect of the invention may be regarded as a hauling cart and not for example as travel luggage.

I claim:

1. A convertible luggage case which is readily converted between a carried condition and a drawn and pushed wheeled condition, comprising:
a receptacle having a floor and a lateral wall projecting from the floor;
at least one wheel disposed on the receptacle, to enable wheeling the convertible luggage case along environmental surfaces; and
a handle assembly pivotally mounted on the receptacle, comprising a pivotal handle member, a pivot mounting disposed to connect the pivotal handle member to the receptacle in a pivotal manner, a support strut having a first end dynamically connected to the handle member and a second end dynamically connected to the receptacle, and a guide disposed to guide at least one of the first end and the second end when the support strut moves into place responsively to the handle member being pivoted.

2. The convertible luggage case according to claim 1, wherein the support strut comprises a pin having an enlarged head and the guide has a groove, and the enlarged head of the pin rides in the groove of the guide.

3. The convertible luggage case according to claim 1, wherein the support strut is slidably mounted to at least one of the receptacle and the handle member.

4. The convertible luggage case according to claim 1, wherein the support strut comprises a pin having an enlarged head and the guide has a groove, the enlarged head of the pin rides in the groove of the guide, and the guide is mounted to one of the handle member and the receptacle, and the support strut is slidably mounted to the other one of the handle member and the receptacle.

5. The convertible luggage case according to claim 2, wherein the guide is mounted to the receptacle at the exterior of the receptacle, and the support strut is pivotally mounted to the handle member.

6. The convertible luggage case according to claim 1, wherein the guide has a detent disposed to releasably secure the support strut in a predetermined position, and wherein the handle member is secured in a respective predetermined position responsively to the support strut being secured in its predetermined position.

7. The convertible luggage case according to claim 2, wherein the detent comprises a slot extension intersecting the groove such that the pin can enter the slot extension and be entrapped therein, thereby securing support strut in a predetermined position, and wherein the handle member is secured in a respective predetermined position responsively to the support strut being secured in its predetermined position.

8. The convertible luggage case according to claim 7, wherein the slot extension is generally downwardly directed, such that the pin can drop into the slot extension by force of gravity.

9. The convertible luggage case according to claim 8, wherein the slot extension is arranged at an oblique angle to a horizontal direction with the lower end of the slot extension located further from the handle member than is the point of intersection of of the slot extension with the groove of the guide, whereby pushing forces imposed by a user on the handle member will promote engagement of the pin with the slot extension and simultaneously will oppose disengagement of the pin from the slot extension.

10. The convertible luggage case according to claim 1, wherein the receptacle has a length and the handle member has a direction of pivot aligned with the length of the receptacle.

11. The convertible luggage case according to claim 1, wherein the handle member has a first leg which engages the receptacle at a first lateral side thereof, a second leg which engages the receptacle at a second lateral side thereof, where the second lateral side is opposed to the first lateral side, and a spanning member which spans and connects the first leg and the second leg.

12. The convertible luggage case according to claim 1, wherein the handle member has a range of pivot, and the receptacle bears a stop disposed to limit the range of pivot.

13. The convertible luggage case according to claim 12, wherein the stop is located such that the handle member is longitudinally aligned with the receptacle at the limit of the range of pivot provided by the stop.

14. The convertible luggage case according to claim 12, wherein the stop is made from a resilient material.

15. The convertible luggage case according to claim 12, further including a retainer disposed to releasably retain the handle member at the limit of its range of pivot.

16. The convertible luggage case according to claim 1, wherein the handle member has a range of pivot, and the support strut is disposed to limit the range of pivot.

17. The convertible luggage case according to claim 1, further comprising a closure which is manually closable to define and close a storage compartment within the floor and the wall.

18. The convertible luggage case according to claim 1, wherein the receptacle comprises a flexible material such that at least one of the floor and at least part of the lateral wall is flexible.

19. A convertible luggage case which is readily converted between a carried condition and a drawn and pushed wheeled condition, comprising:
a receptacle having a floor and a lateral wall projecting from the floor;
at least one wheel disposed on the receptacle, to enable wheeling the convertible luggage case along environmental surfaces;
a handle assembly pivotally mounted on the receptacle, comprising a pivotal handle member, a pivot mounting disposed to connect the pivotal handle member to the receptacle in a pivotal manner, a support strut having a first end dynamically connected to the handle member and a second end dynamically connected to the receptacle, and a guide disposed to guide at least one of the first end and the second end when the support strut moves into place responsively to the handle member being pivoted; and
at least one auxiliary independently closable receptacle.

20. A convertible luggage case which is readily converted between a carried condition and a drawn and pushed wheeled condition, comprising:
a receptacle having a floor and a lateral wall projecting from the floor;
at least one wheel disposed on the receptacle, to enable wheeling the convertible luggage case along environmental surfaces;
a handle assembly pivotally mounted on the receptacle, comprising a pivotal handle member, a pivot mounting disposed to connect the pivotal handle member to the receptacle in a pivotal manner, a support strut having a first end dynamically connected to the handle member and a second end dynamically connected to the receptacle, and a guide disposed to guide at least one of the first end and the second end when the support strut moves into place responsively to the handle member being pivoted; and
a second handle which is retractably extensible from the receptacle for deployment and which is at least partially received within the receptacle for stowage.
